(19) United States
(12) Patent Application Publication
(10) Pub. No.: US 2024/0375945 A1
(43) Pub. Date: Nov. 14, 2024

(54) METAL HYDRIDE COMPOSITES AND HYDROGEN SYSTEMS FORMED THEREFROM

(71) Applicant: Chevron U.S.A. Inc., San Ramon, CA (US)

(72) Inventor: William Boorujy, Livermore, CA (US)

(21) Appl. No.: 18/632,706

(22) Filed: Apr. 11, 2024

Related U.S. Application Data
(60) Provisional application No. 63/465,591, filed on May 11, 2023.

(51) Int. Cl. C01B 3/00; F17C 11/00

(52) U.S. Cl. CPC C01B 3/0078; F17C 11/005; F17C 2221/012; F17C 2227/0341

(57) ABSTRACT

A metal hydride composite includes a compacted form of a metal hydride material, a metal matrix material and a heat conducting material, wherein the metal matrix material is sintered to the metal hydride material.

### PRIORITY CLAIM

The present application claims priority to U.S. Provisional Patent Application Ser. No. 63/465,591, entitled “Metal Hydride Composites and Hydrogen Systems Formed Therefrom,” filed May 11, 2023, the content of each of which is incorporated by reference herein in its entirety.

### BACKGROUND

Energy systems based on hydrogen are interesting candidates to replace fossil fuels for future energy global needs and assist in mitigating the associated environmental problems. Hydrogen is used in numerous industrial fields such as fuel in fuel cells or heat engines, as a reagent for, for example, hydrogenation reactions, or as a source for storing energy, for example, in batteries. Storage is an integral part of hydrogen systems such as fuel cells for producing electricity and electrolyzers in a wide range of applications.

Metal hydrides are solid materials known for their ability to absorb and desorb gaseous hydrogen in response to the removal or addition of heat to the metal hydride, respectively. These materials can be used as, for example, hydrogen storage media and/or as electrode materials for fuel cells, and metal hydride batteries including metal hydride/air battery systems.

### SUMMARY

In accordance with an illustrative embodiment, a metal hydride composite comprises a compacted form of a metal hydride material, a metal matrix material and a heat conducting material, wherein the metal matrix material is sintered to the metal hydride material.

In accordance with another illustrative embodiment, a process for forming a metal hydride composite comprises:
(a) compacting a mixture of a metal hydride material, a metal matrix material and a heat conducting material with pressure to provide a compacted form of the metal hydride material, the metal matrix material and the heat conducting material, and
(b) heating the compacted form of the metal hydride material, the metal matrix material and the heat conducting material to a temperature to sinter the metal matrix material to the metal hydride to provide the metal hydride composite.

In accordance with yet another illustrative embodiment, a hydrogen system comprises:
(a) a heat exchanger comprising at least one element containing heat exchange fluid therein and having an outer surface, the heat exchanger having one or more pieces of a metal hydride composite operatively connected to the outer surface, the metal hydride composite comprising a compacted form of a metal hydride material, a metal matrix material and a heat conducting material, wherein the metal matrix material is sintered to the metal hydride material, and
(b) a controller to operate the heat exchanger to cycle between at least a hydrogen absorption temperature and a hydrogen desorption temperature to effect alternating absorption and desorption of hydrogen by the one or more pieces of the metal hydride composite.

In accordance with still yet another illustrative embodiment, a process comprises:
(a) providing a heat exchanger comprising at least one element containing heat exchange fluid therein and having an outer surface, the heat exchanger having one or more pieces of a metal hydride composite operatively connected to the outer surface, the metal hydride composite comprising a compacted form of a metal hydride material, a metal matrix material and a heat conducting material, wherein the metal matrix material is sintered to the metal hydride material, and
(b) operating the heat exchanger to cycle between at least a hydrogen absorption temperature and a hydrogen desorption temperature to effect alternating absorption and desorption of hydrogen by the metal hydride material.

### BRIEF DESCRIPTION OF THE DRAWINGS

In combination with the accompanying drawing and with reference to the following detailed description, the features, advantages, and other aspects of the implementations of the present disclosure will become more apparent, and several implementations of the present disclosure are illustrated herein by way of example but not limitation. In the accompanying drawings:

FIG. 1A shows a cross-sectional view of a metal hydride composite for use in an assembly for facilitating the absorption and desorption of hydrogen, according to an illustrative embodiment.

FIG. 1B shows a perspective view of the metal hydride composite, according to an illustrative embodiment.

FIG. 2 shows an assembly for facilitating the absorption and desorption of hydrogen with a metal hydride composite, according to an illustrative embodiment.

FIG. 3 shows an assembly for facilitating the absorption and desorption of hydrogen with a metal hydride composite, according to another illustrative embodiment.

FIG. 4 shows an assembly for facilitating the absorption and desorption of hydrogen with a metal hydride composite, according to yet another illustrative embodiment.

### DETAILED DESCRIPTION

Various illustrative embodiments described herein are directed to metal hydride composites and systems containing the metal hydride composites to enhance the rates of absorption and desorption of hydrogen material.

### Definitions

The term “metal hydride composite” as used herein refers to a metal matrix material sintered to a metal hydride material and admixed with a heat conducting material, wherein the metal matrix material immobilizes the metal matrix material sintered to the metal hydride material sufficient to maintain relative spatial relationships between them

The term “relative spatial relationships” as used herein refers to three-dimensional relationships between a metal matrix material sintered to a metal hydride material such as particles of the metal matrix material sintered to the metal hydride material. Such three-dimensional relationships between the particles in the context of the illustrative embodiments described herein will remain substantially unchanged before, during (i.e., during expansion and contraction of the metal hydride material) and after use of the metal hydride composite.

The term “immobilize” refers to the holding of a metal matrix material sintered to a metal hydride material, such that relative spatial relationships are maintained. For example, the particles of a metal matrix material sintered to a metal hydride material may be immobilized, allowing them to move, but keeping the particles substantially in the same geometric relationship to one another before, during (i.e., during expansion and contraction of the metal hydride material) and after use of the metal hydride composite.

The term “occlude” or “occluding” or “occlusion” as used herein refers to absorbing or adsorbing and retaining a substance such as hydrogen. For example, a substance may be occluded chemically or physically, such as by chemisorption or physisorption.

The term “desorb” or “desorbing” or “desorption” as used herein refers to the removal of an absorbed or adsorbed substance such as hydrogen from the metal hydride composite. The hydrogen may be bound physically or chemically.

Much effort has been undertaken to improve the thermal conductivity of metal hydrides and improve methods to transfer heat to metal hydrides. In one area of research, metal hydrides are employed in hydrogen compression. One challenge with this is ensuring that heating and cooling of the metal hydride can occur quickly. Various techniques have been attempted to transfer heat and cooling more quickly from a heat transfer fluid in a heat exchanger to a metal hydride, including a system employing a compacted form of a metal hydride material and a graphite. One concern with the compacted material is poor mechanical stability in that it could spall and crack thereby having poor mechanical stability and falling apart. Despite the efforts to date, there remains a need for improved systems for storing and releasing hydrogen utilizing metal hydride composites.

The illustrative embodiments described herein overcome the foregoing drawbacks by providing a metal hydride composite having improved mechanical stability during use in systems for the storage and/or compression of hydrogen as well as to enhance the rate of heat transfer between a heat exchanger element such as, for example, a tube in a shell-and-tube heat exchanger. In accordance with non-limiting illustrative embodiments, a metal hydride composite includes a compacted form of a metal hydride material, a metal matrix material and a heat conducting material, wherein the metal matrix material is sintered to the metal hydride material.

The term “metal hydride material” or “metal hydride” as used herein refers to metal or metal alloy particles that are capable of forming metal hydrides when contacted with hydrogen e.g., a compound having a transition metal bonded to hydrogen. Such compounds are representative examples of the more general description of metal hydride material: AB, AB₂, A₂B, AB₃ and BCC, respectively. Suitable metal hydrides have interstitial sites therein capable of storing hydrogen. When used in a hydrogen compression system, the tunable thermodynamic properties are leveraged, i.e., a temperature dependence of the absorption and desorption pressure that would provide a desired hydrogen compression ratio in a reasonable temperature range. This can include, for example, AB₅-type intermetallics, AB₂-type intermetallics, vanadium-based BCC solid solution alloys, TiFe-based AB-type intermetallics, and combinations thereof as discussed below.

The selection of the metal hydride material will depend, for example, on pressure ranges required. For some compression applications multi-stage compression may be needed, and different metal hydrides may be selected for each stage. In addition to thermodynamic properties to meet the compression needs, other criteria for metal hydride selection can include high reversible hydrogen storage capacity, fast kinetics of hydrogen absorption/desorption, slow degradation, and low cost. The metal hydride material may occlude hydrogen by, for example, chemisorption, physisorption or a combination thereof.

Representative examples of metals used to form metal hydride material include, but are not limited to, vanadium, magnesium, lithium, aluminum, calcium, transition metals, lanthanides, and intermetallic compounds and solid solutions thereof. Examples of metal alloys used to form metal hydrides include, but are not limited to, LaNi₅, FeTi, Mg₂Ni and ZrV₂. Suitable metal hydrides have interstitial sites therein capable of storing hydrogen. When bound with hydrogen, these compounds form metal hydride complexes such as, for example, MgH₂, Mg₂NiH₄, FeTiH₂ and LaNi₅H₆.

In an illustrative embodiment, a metal hydride material may comprise a low-temperature metal hydride and/or a high-temperature metal hydride. Low-temperature metal hydrides store hydrogen within a temperature range between about −55° C. to about 180° C., or between about −20° C. to about 150° C., or between about 0° C. to about 140° C. High-temperature metal hydrides store hydrogen within a temperature range of at least about 280° C., or at least about 300° C. At the temperatures mentioned, the metal hydrides cannot just store hydrogen but can also release it, i.e., are able to function within these temperature ranges.

In one embodiment, suitable metal hydrides include such metal as, for example, magnesium, titanium, iron, nickel, manganese, nickel, lanthanum, zirconium, vanadium, chromium, or a mixture of two or more of these metals. The metal hydride material may also include a metal alloy comprising at least one of the metals mentioned. In one embodiment, a metal hydride material comprises at least one metal alloy capable of storing hydrogen and releasing it again at a temperature of about 150° C. or less, or within a temperature range from about −20° C. to about 140° C., or from about 0° C. to about 100° C. The at least one metal alloy can be an alloy of, for example, the AB₅ type, the AB type and/or the AB₂ type, where A and B each denote different metals such as magnesium, titanium, iron, nickel, manganese, nickel, lanthanum, zirconium, vanadium and chromium. The indices represent the stoichiometric ratio of the metals in the particular alloy.

In one embodiment, the alloys may be doped with extraneous atoms. According to an illustrative embodiment, the doping level may be up to about 50 atom %, or up to about 40 atom %, or up to about 35 atom %, or up to about 30 atom %, or up to about 25 atom %, or up to about 20 atom %, or up to about 15 atom %, or up to about 10 atom %, or up to about 5 atom %, of A and/or B. The doping can be affected, for example, with magnesium, titanium, iron, nickel, manganese, nickel, lanthanum or other lanthanides, zirconium, vanadium and/or chromium. The doping can be affected here with one or more different extraneous atoms.

In an illustrative embodiment, the metal hydride material can be in any suitable form for forming the metal hydride composite, such as particles, pellets, shavings, fibers, needles and/or other geometries. In one illustrative embodiment, the metal hydride material may take the form of a powder. The metal hydride material does not necessarily have to have a homogeneous configuration. Instead, the configuration may be regular or irregular. For example, in the case of the metal hydride material comprising particles, the particles can be, for example, virtually spherical particles, and likewise particles having an irregular and/or angular outward shape. In addition, the surface of the particles may be smooth, but it is also possible that the surface of the material is rough and/or has unevenness and/or depressions and/or elevations.

In an illustrative embodiment, the metal hydride material can be in powder form. In one embodiment, the powder can contain particles of the metal hydride material having a particle size x₅₀ of about 1 μm to about 250 μm. In one embodiment, the particles of metal hydride material can have a particle size x₅₀ of about 1 μm to about 200 μm. In one embodiment, the particles of metal hydride material can have a particle size x₅₀ of about 1 μm to about 150 μm. In one embodiment, the particles of metal hydride material can have a particle size x₅₀ of about 1 μm to about 100 μm. In one embodiment, the particles of metal hydride material can have a particle size x₅₀ of about 1 μm to about 50 μm. The x₅₀ means that 50% of the particles have a median particle size equal to or less than the value mentioned.

In accordance with an illustrative embodiment, the metal hydride composite in the compacted form contains the metal hydride in an amount greater than about 50 wt. %. In accordance with an illustrative embodiment, the metal hydride composite in the compacted form contains the metal hydride in an amount ranging from about 55 wt. % to about 90 wt. %.

In an illustrative embodiment, as may be combined with one or more of the preceding paragraphs, a suitable metal matrix material includes a hydrogen inert metal matrix material. In an illustrative embodiment, a suitable metal matrix material includes one or more of, for example, copper, aluminum and the like. As one skilled in the art will readily appreciate, the metal matrix material employed herein should have a sintering temperature that is lower than a sintering temperature of the metal hydride material. This way, when heat is applied to the compacted form of the metal hydride material, metal matrix material and heat conducting material as discussed below, the metal matrix material will sinter to the metal hydride material such that the metal matrix material bonds to the metal hydride material.

In an illustrative embodiment, the metal matrix material can be in any suitable form for forming the metal hydride composite, such as particles, pellets, shavings, fibers, needles and/or other geometries. In one illustrative embodiment, the metal matrix material may take the form of a powder. The metal matrix material does not necessarily have to have a homogeneous configuration. Instead, the configuration may be regular or irregular. For example, in the case of the metal matrix material comprising particles, the particles can be, for example, virtually spherical particles, and likewise particles having an irregular and/or angular outward shape. In addition, the surface of the particles may be smooth, but it is also possible that the surface of the material is rough and/or has unevenness and/or depressions and/or elevations.

In an illustrative embodiment, the metal matrix material can be in powder form. In one embodiment, the powder can contain particles of the metal matrix material having a particle size x₅₀ of about 1 μm to about 250 μm. In one embodiment, the particles of metal matrix material can have a particle size x₅₀ of about 1 μm to about 200 μm. In one embodiment, the particles of metal matrix material can have a particle size x₅₀ of about 1 μm to about 150 μm. In one embodiment, the particles of metal matrix material can have a particle size x₅₀ of about 1 μm to about 100 μm. In one embodiment, the particles of metal matrix material can have a particle size xₛₒ of about 1 μm to about 50 μm. The x₅₀ means that 50% of the particles have a median particle size equal to or less than the value mentioned.

In accordance with an illustrative embodiment, the metal hydride composite in the compacted form can contain the metal matrix material in an amount ranging from about 5 wt. % to about 30 wt. %.

In an illustrative embodiment, as may be combined with one or more of the preceding paragraphs, a suitable heat conducting material includes, for example, expanded natural graphite, metal felts, nonoxide ceramics and the like. In one embodiment, the heat conducting material is expanded natural graphite. Expanded natural graphite is a form of graphite modified by chemical and thermal treatments. Expanded natural graphite is a good conductor of heat and consequently improves thermal conductivity of the composite material.

In an illustrative embodiment, the heat conducting material can be in any suitable form for forming the metal hydride composite, such as particles, pellets, shavings, fibers, needles and/or other geometries. In one illustrative embodiment, the heat conducting material may take the form of a powder. The heat conducting material does not necessarily have to have a homogeneous configuration. Instead, the configuration may be regular or irregular. For example, in the case of the heat conducting material comprising particles, the particles can be, for example, virtually spherical particles, and likewise particles having an irregular and/or angular outward shape. In addition, the surface of the particles may be smooth, but it is also possible that the surface of the material is rough and/or has unevenness and/or depressions and/or elevations.

In an illustrative embodiment, the heat conducting material can be in powder form. In one embodiment, the powder can contain particles of the heat conducting material having a particle size x₅₀ of about 1 μm to about 250 μm. In one embodiment, the particles of heat conducting material can have a particle size x₅₀ of about 1 μm to about 200 μm. In one embodiment, the particles of heat conducting material can have a particle size x₅₀ of about 1 μm to about 150μm. In one embodiment, the particles of heat conducting material can have a particle size x₅₀ of about 1 μm to about 100 μm. In one embodiment, the particles of heat conducting material can have a particle size x₅₀ of about 1 μm to about 50 μm. The x₅₀ means that 50% of the particles have a median particle size equal to or less than the value mentioned.

The proportion of the heat conducting material in the metal hydride composite in the compacted form will generally be selected according to thermal conductivity desired for the final material. In accordance with an illustrative embodiment, the metal hydride composite in the compacted form can contain the heat conducting material in an amount ranging from about 5 to about 15wt. %.

In non-limiting illustrative embodiments, as may be combined with one or more of the preceding paragraphs, the mixture may further include one or more additional ingredients, additives or structures that improve thermal or mechanical properties of the metal hydride composite. Examples of additional additives include, but are not limited to, graphite flakes, carbon fibers, carbon nanofibers, carbon nanotubes, polymer fibers, metal fibers, wire, metal particles, glass fibers, and combinations thereof. Examples of structural additives include carbon flakes, carbon nanotubes, fibers of fiberglass, carbon fibers, carbon nanofibers and combinations thereof.

In one embodiment, as may be combined with one or more of the preceding paragraphs, an additive includes a lubricant and/or fire retardant. Suitable fire retardants include, for example, phosphonium ammonium borate (i.e., phospho-ammonium boron); 3,4,5,6-dibenzo-1,2-oxaphosphane-2-oxide or 9,10-dihydro-9-oxa-10-phospaphenanthrene-10-oxide (OPC) [CAS Registry Number 35948-25-5]; sulfamic acid monoammonium salt (ammonium sulfamate) [CAS Registry Number 7773-06-0]; di-n-butyltin oxide (DBTO) [CAS Registry Number 818-08-6]; di-n-octyltin oxide (DOTO) [CAS Registry Number 780-08-6]; dibutyltin diacetate di-n-butyltin diacetate (NS-8) [CAS Registry Number 1067-33-0]; dibutyltin dilaurate di-n-butyltin dilaurate (Stann BL) [CAS Registry Number 77-58-7]; ferrocene; iron pentacarbonyl; ammonium sulfate; ammonium phosphate; zinc chloride; and combinations thereof.

In accordance with non-limiting illustrative embodiments, if desired, the mixture of metal hydride material, metal matrix material and heat conducting material can be hydrided prior to the compacting step discussed below by contacting the mixture with hydrogen gas at a pressure sufficient enough to hydride the mixture of metal hydride material, metal matrix material and heat conducting material. Generally, a pressure from about 100 to about 500 psi can be used to accomplish this, although higher hydrogen pressures may be desirable.

In accordance with non-limiting illustrative embodiments, the metal hydride composite can be obtained by first compacting a mixture of a metal hydride material, a metal matrix material and a heat conducting material with pressure to provide a compacted form of the metal hydride material, metal matrix material and heat conducting material. For example, in an illustrative embodiment, a mixture of particles of the metal hydride material, metal matrix material and heat conducting material are compressed to form the compacted form. The mixture of particles is produced in a conventional manner, for example in a mixer, at ambient temperature and at atmospheric pressure in order to thoroughly disperse the particles.

The mixture is then placed in a suitable mold or die for compression. A suitable mold or die can be any of those known in the art for compressing the mixture into a pellet shape. The pressure exerted during compression is selected in particular according to the porosity desired in the composite material. In an illustrative embodiment, compression is carried out at room temperature.

Following compression, the compacted form is heated to a temperature and for a time period sufficient to sinter the metal matrix material to the metal hydride material such that the metal matrix material bonds to the metal hydride material to provide the metal hydride composite. The sintering conditions such as a suitable temperature and time period are within the purview of one skilled in the art. In one illustrative embodiment, the compacted form is heated after being released from the mold or die. In another illustrative embodiment, the compacted form is heated while remaining in the mold or die. In one embodiment, the compacted form is heated to a temperature capable of sintering the metal matrix material to the metal hydride material. In another embodiment, the compacted form is heated to a temperature below the sintering temperature of the metal hydride material. In an illustrative embodiment, the heating can be carried out by placing the compacted form in, for example, an oven or furnace such as a continuous sintering furnace.

In one embodiment, the metal hydride composite according to illustrative embodiments described herein has a tensile strength and toughness greater than a compacted form of a metal hydride and an expanded natural graphite.

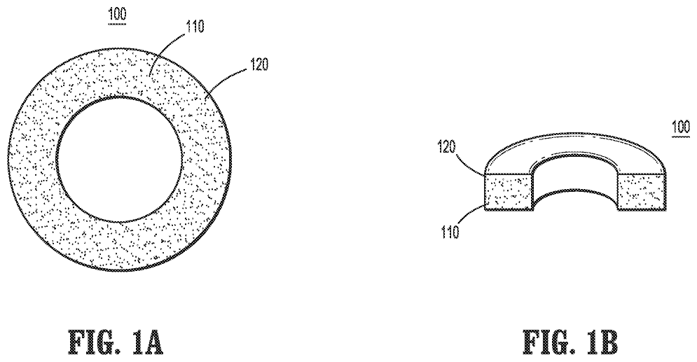

A representative example of a metal hydride composite according to illustrative embodiments described herein is generally illustrated in FIGS. 1A and 1B. FIGS. 1A and 1B show metal hydride composite 100 having particles 110 of metal matrix material sintered to a metal hydride material in heat conducting material 120.

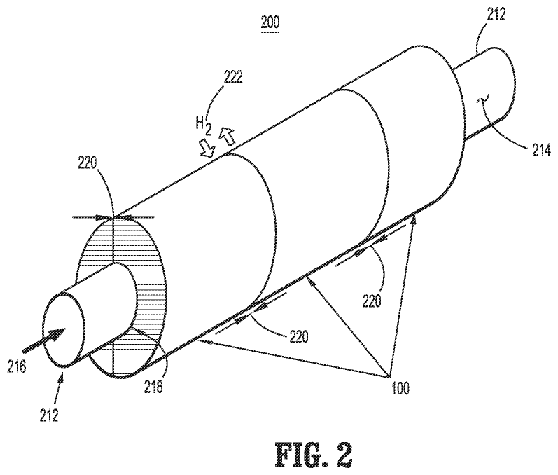

In accordance with non-limiting illustrative embodiments, the metal hydride composite 100 of FIGS. 1A and 1B can be used in an assembly (i.e., hydrogen system) for facilitating the absorption and desorption of hydrogen with the metal hydride composite as illustrated in FIGS. 2-4. Referring to FIG. 2, assembly 200 includes a heat exchanger element 212 having an outer surface 214 of a heat exchanger that is adapted to contain a heat exchange fluid therein 216. In an illustrative embodiment, the heat exchanger element 212 can be of any suitable form or shape of an clement in a heat exchanger. In one embodiment, the heat exchanger element 212 is configured as a tube in a shell-and-tube heat exchanger. The heat exchange fluid therein 216 can be, for example, water at various temperatures, ranging from cooling water to steam, e.g., 150-pound steam at about 360° F. to about 375° F. In one illustrative embodiment, the heat exchanger can be operated at a hydrogen absorption temperature, for example, a temperature ranging from about 75° F. to about 80° F., to store hydrogen in the metal hydride composite. In one illustrative embodiment, the heat exchanger can be operated to cycle between at least a hydrogen absorption temperature, e.g., about 75° F. to about 80° F., and a hydrogen desorption temperature e.g., about 360° F. to about 375° F., to effect alternating absorption and desorption of hydrogen 222 by metal hydride composite 100.

The metal hydride composite 100 is operatively connected to the outer surface 214 of the heat exchanger element 212 such that the metal hydride composite 100 is in contact with the outer surface 214. In non-limiting illustrative embodiments, the metal hydride composite 100 can be operatively connected to the outer surface 214 in one piece or in multiple pieces. In an illustrative embodiment, the metal hydride composite 100 can be divided into multiple pieces such as two or more pieces that together fit around the heat exchanger element 212 such that they contact its outer surface 214. In one embodiment, each piece of the metal hydride composite 100 can be between about 0.25 to about 2 inches thick. In another embodiment, each piece of the metal hydride composite 100 can be between about 0.5 to about 1 inch thick. The pieces of the metal hydride composite 100 can vary in axial length such that both axially and radially, a gap 220 can be provided between the pieces to allow for expansion and contraction due to thermal stress and hydrogen absorption and desorption. In one embodiment, the gap 220 can be, for example, up to about ⅛ inch. The metal hydride composite 100 can be of any suitable form or shape to be configured around heat exchanger element 212. For example, a suitable shape for the metal hydride composite 100 can be semi-toroidal (rectangular-toroidal) shaped as illustrated in FIGS. 1A and 1B.

In one embodiment, the metal hydride composite 100 is operatively connected to the outer surface 214 of the heat exchanger element 212 by a thermally conductive adhesive layer 218 between the metal hydride composite 100 and the heat exchanger element 212. The term “thermally conductive” as used herein shall be understood to mean a layer having a thermal conductivity of greater than about 0.3 W/m−K and up to about 60 W/m−K or more. In one embodiment, the thermally conductive layer is a thermally conductive adhesive layer. Thermally conductive adhesive layer 218 can be applied to the outer surface 214 of the heat exchanger element 212 either as a bulk adhesive or in the form of an adhesive tape. Bulk adhesive can be applied by brush, roller, or any other suitable applicator. After the application of thermally conductive adhesive layer 218, the pieces of metal hydride composite 100 are positioned in contact with thermally conductive adhesive layer 218 to secure the metal hydride composite 100 to the heat exchanger element 212.

Suitable thermally conductive adhesive material for thermally conductive adhesive layer 218 can be any thermally conductive adhesive or epoxy resin capable of maintaining adhesion, once in place and cured if required, at temperatures between the hydrogen absorption and desorption temperatures of the metal hydride composite selected. Thermally conductive adhesive material can include, for example, thermally conductive adhesives available from such sources as, for example, Panacol (Hessen, Germany) under the tradename Elecolit®, DELO Industrial Adhesives (Windach, Germany) under the tradename DELO MONOPOX TC2270, and Henkel (Düsseldorf, Germany) under the tradename Bergquist Liqui Bond TLB SA3500.

In an illustrative embodiment, thermally conductive adhesive layer 218 can be a layer of thermally conductive solder. Solder is well-known as a fusible metal alloy that is melted and then solidified to join two objects together. Suitable thermally conductive solder used can be any solder capable of conducting heat and maintaining adhesion (once set) at temperatures between the hydrogen absorption and desorption temperatures of the metal hydride composite selected. In one embodiment, the melting temperature of the solder is greater than the hydrogen desorption temperature when the system will be used for absorption and desorption of hydrogen from the metal hydride. Such solder types include, but are not limited to, alloys containing gold, silver, tin and/or copper, tin having a melting temperature of 232° C., a multicore lead-free 99C solder which is a 99.3% tin/0.7% copper alloy having a melting temperature of 227° C. and a thermal conductivity of 40 W/m-K, a multicore lead-free 97C solder which is a 97% tin/3% copper alloy having a melting temperature 230° C. to 250° C., a multicore lead-free SAC3 solder which is a 96.5% tin/0.5% copper/3% silver alloy having a melting temperature of 217° C. to 219° C. and a thermal conductivity of 60 W/m−K, and a MC1 solder having a melting temperature of 232° C.

In an illustrative embodiment, thermally conductive solder can be applied to the outer surface 214 of the heat exchanger clement 212 in the form of, for example, a wire, ribbon, sheet, or a solder paste. After the application of the solder on the outer surface 214 of the heat exchanger element 212, the pieces of metal hydride composite 100 are positioned in contact with the solder and then heat is applied to the assembly 200 to reach the melting temperature of the solder. In one embodiment, the heat may be applied by heating the assembly 200 in an oven to the melting temperature of the solder. In another embodiment, the heat exchanger element 212 can be heated by any suitable method including, for example, conduction or induction heating to bring the solder to the melting temperature of the solder. The molten solder fills in the space between the pieces of metal hydride composite 100 and the heat exchanger element 212. The solder then cools to solidify and bond the metal hydride composite 100 to the heat exchanger element 212.

In an illustrative embodiment, thermally conductive adhesive layer 218, after setting or curing as required, is as relatively thin as necessary to bond the pieces of metal hydride composite 100 to the to the outer surface 214 of the heat exchanger element 212. The necessary thickness of thermally conductive adhesive layer 218 will vary depending on the metal hydride composite and thermal stresses given the temperatures and pressures used. In an illustrative embodiment, a thickness of thermally conductive adhesive layer 218 can be, for example, up to about ⅛ inch thick.

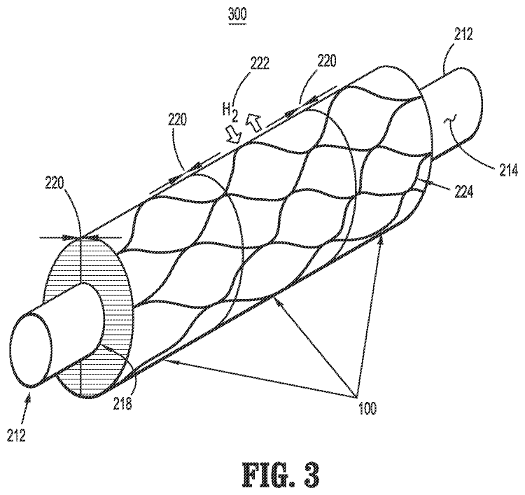

In an illustrative embodiment, as may be combined with one or more of the preceding paragraphs, FIG. 3 shows assembly 300 including pieces of metal hydride composite 100 operatively connected to the outer surface 214 of the heat exchanger element 212 with gap 220 being provided between the pieces to allow for expansion and contraction due to thermal stress and hydrogen absorption and desorption. In one embodiment, the gap 220 can be, for example, up to about ⅛ inch. The pieces of metal hydride composite 100 are further secured to the heat exchanger clement 212 by a sheath of expanded metal or wire mesh netting 224. The sheath of expanded metal or wire mesh netting 224 is placed over the metal hydride composite 100 such that the sheath of expanded metal or wire mesh netting 224 surrounds the metal hydride composite 100 and holds it securely in place in direct contact with the heat exchanger element 212. In one embodiment, the sheath of expanded metal or wire mesh netting 224 is formed of a suitable metal such as, for example, copper, aluminum, stainless steel, and titanium alloys. Expanded metal is typically formed by slitting and stretching a metal sheet to create diamond shaped openings. In one embodiment, a sheath of expanded metal 224 is preformed into a cylindrical shape and positioned around the metal hydride composite 100 to hold it in place, optionally using a cone to facilitate stretching and installing the sheath of expanded metal 224 over the metal hydride composite 100. Alternatively, the sheath of expanded metal 224 is a flat sheet that is wrapped around the metal hydride composite 100, and secured using any suitable attachment such as, for example, ties, connectors, springs, and the like to hold the sheet securely in place. The wire mesh netting 224 can be formed from a wire mesh netting material. Wire mesh netting material is typically formed by placing strands of wire rope parallel to each other and connecting adjacent wire ropes with clamps or other connectors.

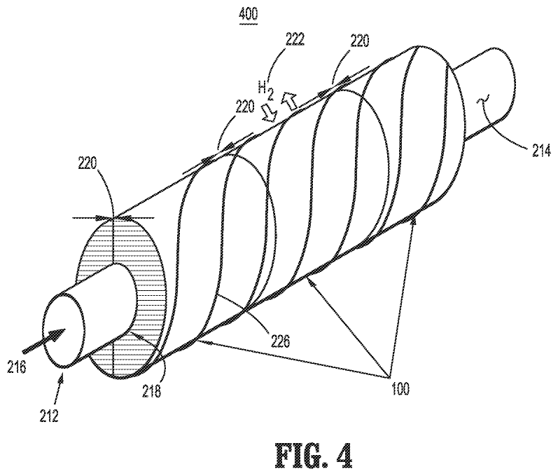

In an illustrative embodiment, as may be combined with one or more of the preceding paragraphs, FIG. 4 shows assembly 400 including pieces of metal hydride composite 100 operatively connected to the outer surface 214 of the heat exchanger element 212 with gap 220 being provided between the pieces to allow for expansion and contraction due to thermal stress and hydrogen absorption and desorption. In one embodiment, the gap 220 can be, for example, up to about ⅛ inch. The pieces of metal hydride composite 100 are further secured to the heat exchanger element 212 by a flexible wire 226. The flexible wire 226 is placed over the metal hydride composite 100 such that the flexible wire 226 surrounds the metal hydride composite 100 and holds it securely in place in direct contact with the heat exchanger element 212. In one embodiment, the flexible wire 226 is formed of a suitable metal such as, for example, copper, aluminum, stainless steel, and titanium alloys.

In an illustrative embodiment, as may be combined with one or more of the preceding paragraphs, different embodiments can be combined to provide additional durability. For example, in non-limiting illustrative embodiments, the sheath of expanded metal or wire mesh netting 224 or the flexible wire 226 as shown in respective FIGS. 3 and 4 can be placed over the metal hydride composite 100 which in turn is adhered to the heat exchanger element 212 using a thermally conductive adhesive layer 218 as shown in FIG. 2.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A metal hydride composite comprising a compacted form of a metal hydride material, a metal matrix material and a heat conducting material, wherein the metal matrix material is sintered to the metal hydride material.

2. The metal hydride composite according to claim 1, wherein the metal hydride material comprises one or more of magnesium, titanium, iron, nickel, manganese, nickel, lanthanum, zirconium, vanadium, chromium, mixtures thereof and metal alloys thereof.

3. The metal hydride composite according to claim 2, wherein the metal matrix material comprises one or more of copper and aluminum.

4. The metal hydride composite according to claim 3, wherein the heat conducting material is an expanded natural graphite.

5. The metal hydride composite according to claim 1, comprising:
about 55 wt. % to about 90 wt. % of the metal hydride material;
about 5 wt. % to about 30 wt. % of the metal matrix material; and
about 5 wt. % to about 15 wt. % of the heat conducting material.

6. The metal hydride composite according to claim 1, wherein the metal matrix material comprises a hydrogen inert metal.

7. The metal hydride composite according to claim 1, wherein the compacted form of a metal hydride material, a metal matrix material and a heat conducting material is a compacted form of a mixture of particles of the metal hydride material, the metal matrix material and the heat conducting material.

8. A process for forming a metal hydride composite comprising:
(a) compacting a mixture of a metal hydride material, a metal matrix material and a heat conducting material with pressure to provide a compacted form of the metal hydride material, the metal matrix material and the heat conducting material; and
(b) heating the compacted form of the metal hydride material, the metal matrix material and the heat conducting material to a temperature to sinter the metal matrix material to the metal hydride to provide the metal hydride composite.

9. The process according to claim 8, wherein the metal hydride material comprises one or more of magnesium, titanium, iron, nickel, manganese, nickel, lanthanum, zirconium, vanadium, chromium, mixtures thereof and metal alloys thereof.

10. The process according to claim 9, wherein the metal matrix material comprises one or more of copper and aluminum.

11. The process according to claim 10, wherein the heat conducting material is an expanded natural graphite.

12. The process according to claim 8, wherein the metal hydride composite comprises:
about 55 wt. % to about 90 wt. % of the metal hydride material;
about 5 wt. % to about 30 wt. % of the metal matrix material; and
about 5 wt. % to about 15 wt. % of the heat conducting material.

13. The process according to claim 8, wherein the metal matrix material comprises a hydrogen inert metal.

14. The process according to claim 8, wherein compressing the mixture of the metal hydride material, the metal matrix material and the heat conducting material comprises placing the mixture of the metal hydride material, the metal matrix material and the heat conducting material in a mold or die and compressing the mixture.

15. The process according to claim 8, wherein the compacted form of a metal hydride material, a metal matrix material and a heat conducting material is a compacted form of a mixture of particles of the metal hydride material, the metal matrix material and the heat conducting material.

16. A hydrogen system comprising:
(a) a heat exchanger comprising at least one element containing heat exchange fluid therein and having an outer surface, the heat exchanger having one or more pieces of a metal hydride composite operatively connected to the outer surface, the metal hydride composite comprising a compacted form of a metal hydride material, a metal matrix material and a heat conducting material, wherein the metal matrix material is sintered to the metal hydride material; and
(b) a controller to operate the heat exchanger to cycle between at least a hydrogen absorption temperature and a hydrogen desorption temperature to effect alternating absorption and desorption of hydrogen by the one or more pieces of the metal hydride composite.

17. The hydrogen system according to claim 16, wherein the heat exchanger further comprises a thermally conductive adhesive layer between the one or more pieces of the metal hydride composite and the heat exchanger for securing the one or more pieces of the metal hydride composite to the outer surface of the heat exchanger.

18. The hydrogen system according to claim 17, wherein thermally conductive adhesive layer comprises a thermally conductive solder.

19. The hydrogen system according to claim 16, wherein the metal hydride material comprises one or more of magnesium, titanium, iron, nickel, manganese, nickel, lanthanum, zirconium, vanadium, chromium, mixtures thereof and metal alloys thereof, the metal matrix material comprises one or more of copper and aluminum and the heat conducting material is an expanded natural graphite.

20. The hydrogen system according to claim 16, wherein the metal hydride composite comprises:
about 55 wt. % to about 90 wt. % of the metal hydride material;
about 5 wt. % to about 30 wt. % of the metal matrix material; and
about 5 wt. % to about 15 wt. % of the heat conducting material.
